(19) United States
(12) Patent Application Publication
(10) Pub. No.: US 2004/0029593 A1
(43) Pub. Date: Feb. 12, 2004

(54) Global positioning system receiver with high density memory storage

(76) Inventor: Davey N. Skinner, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/215,497

(22) Filed: Aug. 9, 2002

(51) Int. Cl. H04B 1/00

(52) U.S. Cl. 455/456.1; 455/456.6

(57) ABSTRACT

A global positioning system (GPS) receiver includes an atomic resolution storage (ARS) device configured to store GPS information. The ARS device includes an electron emitter, a media and a micromover operable to move the electron emitter relative to the media to read or write GPS information at the media.

### THE FIELD OF THE INVENTION

The present invention generally relates to a global positioning system (GPS) receiver, and more particularly, to a GPS receiver which includes an atomic resolution storage device.

### BACKGROUND OF THE INVENTION

The global positioning system (GPS) is a collection of satellites owned by the U.S. government which provide accurate and world-wide positioning and navigation information. The GPS satellites are distributed among six orbits with four satellites per orbit and are inclined at about fifty-five degrees from the equator. Each consecutive satellite orbit is separated by about sixty degrees longitude across the equator. Because the GPS satellites have high accuracy atomic clocks on board, and have a database of current and expected positions for each of the satellites, a GPS receiver can determine a location from each one of a small number of satellites by using the travel time of a radio message between each satellite and the GPS receiver. Through triangulation of signals from the satellites, the GPS receiver can determine a location on earth to an accuracy of about ten to fifteen feet.

The GPS system was originally developed for use by the U.S. military for applications such as tracking the movement of soldiers and equipment on the battlefield and providing navigation information for military aircraft and ships at sea. GPS receivers are available for commercial applications and have become increasingly affordable and popular. For example, low-cost and portable GPS receivers have been made possible by improvements in technology which have reduced the weight, power consumption and data storage capability of the receivers. Software databases for use on the GPS receivers have become available. These databases include navigation maps for marine and aviation applications and detailed topographical maps which include detailed contour and elevation information.

The databases are typically provided on CD-ROMs and can be transferred to internal memory contained within the portable GPS receivers or to memory cartridges which can be added or removed as desired from the portable GPS receivers. Currently the amount of information available on the CD-ROMs exceeds the storage capacity of the portable GPS receiver memory. CD-ROM disks have a storage capacity of 650 megabytes, while the internal memory or memory cartridges can only store up to 32 megabytes of data. As a consequence, information desired to be displayed on the portable GPS receivers must be provided in installments which limits the versatility of the portable receivers, or must be provided at a level of resolution which is far less than the positional accuracy available from the GPS satellites.

In view of the above, there is a need for an improved portable GPS receiver that can store information which can be displayed on the portable GPS receiver at a high level of resolution without having to frequently update the stored information.

### SUMMARY OF THE INVENTION

The present invention is a global positioning system (GPS) receiver. In one embodiment, the GPS receiver includes an atomic resolution storage (ARS) device configured to store GPS information. The ARS device includes an electron emitter, a media and a micromover operable to move the electron emitter relative to the media to read or write GPS information at the media.

### BRIEF DESCRIPTION OF THE DRAWINGS

FIG. 1 is a block diagram illustrating one exemplary embodiment of a global positioning system receiver which includes atomic resolution storage devices in accordance to the present invention.

FIG. 2 is a diagram illustrating a first exemplary embodiment of a global positioning system receiver wherein information is transferred between the global positioning system receiver and an external source.

FIG. 3 is a diagram illustrating a second exemplary embodiment of a global positioning system receiver wherein information is transferred between the global positioning system receiver and an external source.

FIG. 4 is a diagram illustrating a third exemplary embodiment of a global positioning system receiver wherein information is transferred between the global positioning system receiver and an external source.

FIG. 5 is a side view illustrating one exemplary embodiment of an atomic resolution storage device used in a global positioning system receiver according to the present invention.

FIG. 6 is a simplified schematic diagram illustrating one exemplary embodiment of storing information in the atomic resolution storage device illustrated in FIG. 5.

FIG. 7 is a top view illustrating one exemplary embodiment of an atomic resolution storage device used in a global positioning system receiver which is taken along line 7-7 of FIG. 5.

FIG. 8 is a diagram illustrating one exemplary embodiment of electron emitters reading from storage areas of the atomic resolution storage device of FIG. 6.

FIG. 9 is a diagram illustrating another exemplary embodiment of electron emitters reading from storage areas of an atomic resolution storage device.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

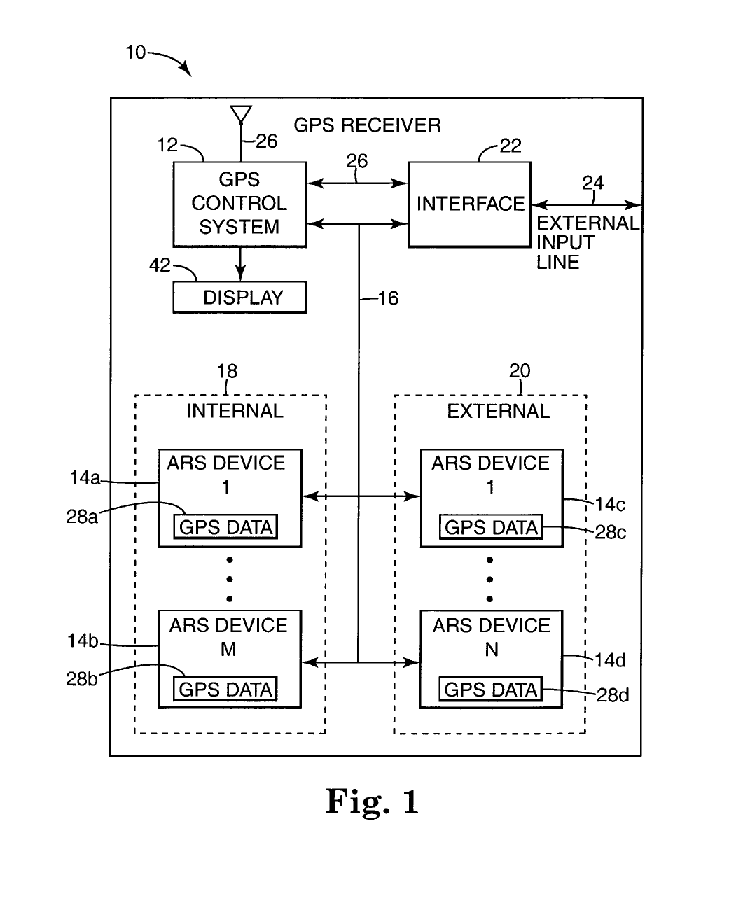

In FIG. 1, one exemplary embodiment of a global positioning system (GPS) receiver according to the present invention is illustrated at 10. The GPS receiver 10 includes a GPS control system 12 and a plurality of atomic resolution storage (ARS) devices 14. The ARS devices 14 are configured to communicate with the GPS control system 12 via line 16 as high resolution storage devices which are relatively low in cost, have increased memory storage capacity and have decreased power and space requirements relative to other known memory devices in GPS receivers.

In the illustrated embodiment, ARS devices 14 are partitioned into 1-M internal ARS devices 14 which are illustrated at 18 as ARS devices 14a and 14b. ARS devices 14 are further partitioned into 1-N external ARS devices 14 which are illustrated at 20 as ARS devices 14c and 14d. In the illustrated embodiment the 1-M internal ARS devices 14 illustrated at 18 are located within GPS receiver 10 and are not configured to be easily added or removed. The 1-N external ARS devices 14 illustrated at 20 are readily accessible and are configured to be added or removed as desired. In one embodiment, one or more of the 1-N external ARS devices 14 illustrated at 20 are housed within cartridges which are suitably configured to be inserted into GPS receiver 10 and electrically couple to line 16. In another embodiment, one or more of the 1-N external ARS devices 14 illustrated at 20 are housed within cartridges which are suitably configured to be inserted into an external cartridge drive which is electrically coupled to an external input line 24.

In the illustrated embodiment, M and N are any suitable number which is one or greater. In other embodiments, GPS receiver 10 only includes the internal 1-M ARS devices 14 illustrated at 18, or only includes the external 1-N ARS devices 14 illustrated at 20. In various embodiments, the ARS devices 14 illustrated at 18 are located on a single semiconductor unit (e.g., a chip) or are located on separate semiconductor units. In various embodiments, the ARS devices 14 illustrated at 20 are located on a single semiconductor unit or are located on separate semiconductor units.

In the illustrated embodiment, ARS devices 14 communicate with the GPS control system 12 via line 16. In various embodiments, other external sources or peripherals such as a personal computer may be connected to GPS receiver 10 through the external input line 24. In one embodiment, line 16 is a communication bus. In one embodiment, line 16 is defined as an industry standard ATA or uniform serial bus (USB) communication bus which allows multiple devices to communicate on a common bus. In one embodiment, line 16 uses a bus protocol and hardware interface which allows GPS control system 12, interface 22 and ARS devices 14 to communicate over line 16. In other embodiments, line 16 can be a communications bus which follows other suitable bus protocols.

In the illustrated embodiment, GPS control system 12 controls ARS devices 14 via line 16 and controls the transfer of information between external input line 24 and ARS devices 14. In other embodiments, the function of GPS control system 12 is incorporated into other logic circuitry within GPS receiver 10. In the illustrated embodiment, GPS control system 12 keeps track of the memory capacity of the internal 1-M ARS devices 14 illustrated at 18 and the external 1-N ARS devices 14 illustrated at 20 so that logic within GPS receiver 10 or an external source coupled to external input line 24 can communicate with ARS devices 14.

In the illustrated embodiment, GPS control system 12 includes control electronics connected to line 16 which allow GPS control system 12 to communicate with ARS devices 14. In other embodiments, the control electronics of GPS control system 12 are located within corresponding ARS devices 14. In other embodiments, GPS control system 12 includes a cache system, queuing, and other systems, components or devices used in the execution of read and write commands (i.e., the reading and writing of data) within GPS receiver 10.

In the illustrated embodiment, interface 22 communicates with GPS control system 12 via line 26 and receives commands from and sends transmitting status to GPS control system 12. In various embodiments, interface 22 controls one or more buffer memories which store commands received from GPS control system 12 or store information read from either ARS devices 14 or over external line input 24. The buffer memory can include volatile memory such as dynamic random access memory (DRAM). In other embodiments, interface 22 can perform other suitable functions such as error detection and correction.

In the illustrated embodiment, GPS control system 12 controls the storage of information within ARS devices 14. The information is illustrated as GPS data 28a, 28b, 28c and 28d stored respectively in, ARS devices 14a, 14b, 14c and 14d. In various embodiments, one or more of ARS devices 14 store the information which includes, but is not limited to, navigation maps for marine and aviation applications and detailed topographical or three-dimensional maps which include detailed contour and elevation information.

In the illustrated embodiment, GPS receiver 10 receives transmissions from GPS satellites via antenna 26. GPS control system 12 determines a location from each satellite through triangulation of signals from the satellites by using the travel time of a radio message between each satellite and the GPS receiver. GPS control system 12 reads the information stored in ARS devices 14 and displays on display 42 the location of GPS receiver 10 and the information. The information displayed on display 42 enables a determination of the location of GPS receiver 10 relative to the displayed information. In one embodiment, the displayed information includes a navigation map and indicates the location of GPS receiver 10 relative to the navigation map. In another embodiment, the displayed information includes a topographical or three-dimensional map and indicates the location of GPS receiver 10 relative to the topographical or three-dimensional map. In other embodiments, the information displayed on display 42 can be any suitable information on which the location of GPS receiver 10 can be displayed.

In various embodiments, GPS receiver 10 can be coupled to a Differential GPS (DGPS) unit to enhance the accuracy of the location which is displayed on display 42. The DGPS unit uses a Frequency Modulation (FM) receiver to triangulate a location from local FM transmitters. Once the location is determined by the DGPD unit, the location can be displayed on display 42.

In the illustrated embodiment, each ARS device 14 includes a plurality of electron emitters, one or more medium surfaces and one or more micromover(s). In one embodiment, each electron emitter is positioned near an associated partitioned area on the medium surface. The corresponding micromover provides for movement of the electron emitter relative to the medium surface to aid in the redundant reading and writing of data at multiple partitioned areas on the medium surface. In one aspect, the micromover is attached to the corresponding partitioned area of the medium and the corresponding electron emitter is held stationary, for movement of the medium relative to the electron emitter.

Each atomic resolution storage device used in the present invention is small in size, has low power requirements, and provides for non-volatile, high density storage of data. The term “atomic resolution storage device” as used herein, is defined as a non-volatile memory storage device or component capable of storing a large volume of data, such as megabytes to gigabytes of data points, within a relatively small storage area and requiring very low power. Each atomic resolution storage device includes one or more electron emitters, a storage medium, and one or more micromovers and associated circuitry for the redundant reading and writing of data at the storage medium. The terms medium and media are used interchangeably herein when used in reference to a storage area. In one embodiment, each ARS device 14 includes a plurality of spaced apart electron emitters, wherein each electron emitter is responsible for a number of storage areas on the storage medium. In various embodiments, suitable electron emitters include flat emitters and tip emitters. In other embodiments, other emitter types having other suitable shapes can be used. As will be understood by persons having ordinary skill in the art, the ARS devices 14 in accordance with the present invention can include other non-volatile memory storage device types which are capable of storing a large amount of information within a relatively small storage area and which have very low power requirements.

In one embodiment, ARS device 10 has a data storage capacity of hundreds of megabytes to hundreds of gigabytes. In one embodiment, ARS device 10 has power requirements of less than one watt (instantaneous) and less than a few tenths of a milliwatt (standby).

An ARS device suitable for use in GPS receiver 10 is disclosed in U.S. Pat. No. 5,557,596 to Gibson et al., issued Sep. 17, 1996, entitled “Ultra-High Density Storage Device,” which is incorporated herein by reference. Other suitable high density storage ARS devices suitable for use within in GPS receiver 10 according to the present invention will become apparent to those skilled in the art after reading the present application.

An ARS device packaging approach suitable for one or more of the 1-N external ARS devices 14 illustrated at 20 is disclosed in U.S. Pat. No. 6,310,794 to Carter, issued Oct. 30, 2001, entitled “Upgradable Storage System,” which is incorporated herein by reference. Other suitable high density storage ARS device packaging approaches suitable for use within GPS receiver 10 according to the present invention will become apparent to those skilled in the art after reading the present application.

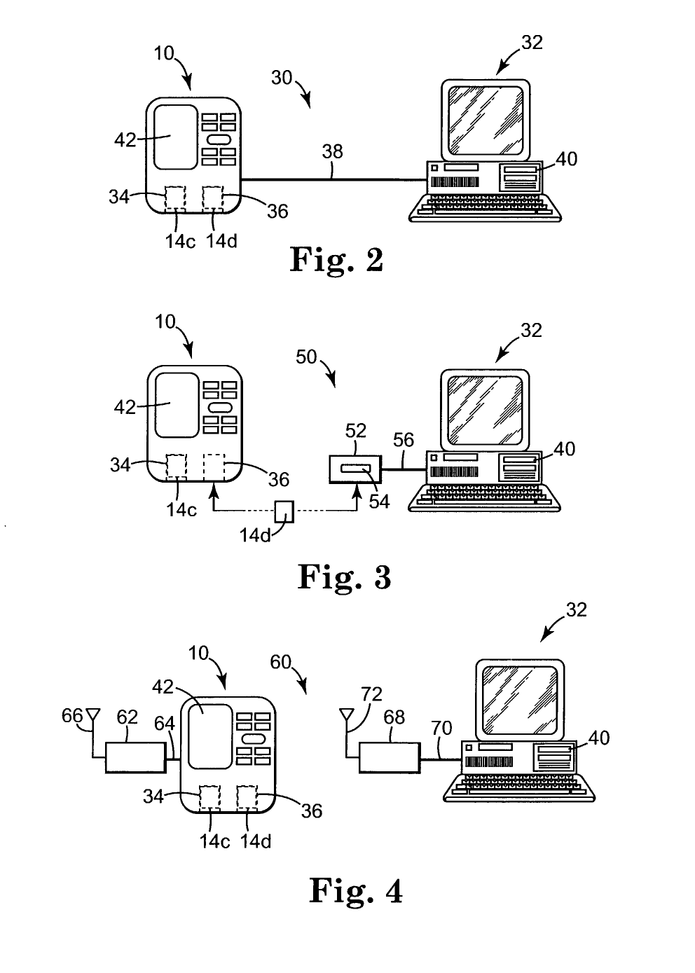

FIGS. 2 through 4 illustrate three embodiments of the present invention wherein information is transferred between GPS receiver 10 and an external source. In the illustrated embodiments, the information is provided on one or more CD-ROMs. External sources such as a personal computer 32 can be used to download information contained on the CD-ROMs to ARS devices 14. In the illustrated embodiment, information is also transferred from ARS devices 14 to personal computer 32. In the illustrated embodiments, the CD-ROMs have an information storage capacity of 650 megabytes and ARS devices 14 have an information storage capacity ranging from hundreds of megabytes to hundreds of gigabytes. In other embodiments, the information is provided on other mediums which include, but are not limited to, DVD optical disks which have storage capacity of 4.6 gigabytes.

In the illustrated embodiment, the information which can be downloaded to ARS devices 14 in GPS receiver 10 includes, but is not limited to, detailed maps illustrating hiking trails, roads and other landmarks such as service stations and hotels. In other embodiments, the information to be downloaded includes, but is not limited to, mapping information such as detailed marine maps illustrating shoreline details for inland lakes and reservoirs, the location of nautical aids such as lights, buoys, sound signals and day beacons, and the location of obstructions such as small island wrecks, and the location of boat rams, dams, and other danger areas.

FIG. 2 is a diagram illustrating a first exemplary embodiment of information being transferred between a personal computer 32 and GPS receiver 10. In the first exemplary embodiment, GPS receiver 10 includes ARS devices 14a-14d. In other embodiments, GPS receiver 10 can have any suitable number of ARS devices 14. ARS devices 14c and 14d are housed within cartridges which include electrical contacts which are configured to provide an electrical connection between line 16 and ARS devices 14c and 14d. The cartridges containing ARS devices 14c and 14d are inserted into connection slots 34 and 36 of GPS receiver 10 which have corresponding and aligned electrical contacts disposed therein which are electrically coupled to external input line 24.

In the illustrated embodiment, a cable connector 38 electrically couples the external input line 24 of GPS receiver 10 to the personal computer 32. In the illustrated embodiment, the information to be downloaded is contained on a CD-ROM which is inserted into CD-ROM drive 40 of personal computer 32. In one embodiment, cable connector 38 is a serial data cable. In one embodiment, cable connector 38 electrically couples to a DB-9 serial connection port located on the back side of personal computer 32. In other embodiments, cable connector 38 electrically couples to other suitable connection ports on personal computer 32.

In the illustrated embodiment, the transfer of information from the CD-ROM inserted into CD-ROM drive 40 and ARS devices 14 within GPS receiver 10 is initiated with a sequence of commands from either personal computer 32 or GPS receiver 10. In other embodiments, information is downloaded to ARS devices 14 within GPS receiver 10 from memory located within personal computer 32. In other embodiments, the information is transferred between ARS devices 14 within GPS receiver 10 and other suitable peripheral devices.

FIG. 3 is a diagram illustrating a second exemplary embodiment of information being transferred between personal computer 32 and GPS receiver 10. In the illustrated embodiment, information is downloaded from personal computer 32 to ARS device 14d after ARS device 14d is electrically decoupled and transferred from connection slot 36 of GPS receiver 10 to connection slot 54 of cartridge drive 52. In another embodiment, information is downloaded to ARS device 14c which is electrically decoupled and transferred from connection slot 34 of GPS receiver 10 to connection slot 54 of ARS cartridge drive 52. In the illustrated embodiment, ARS cartridge drive 52 is electrically coupled to personal computer 32 through a cable connector 56. In various embodiments, one or more CD-ROMs are inserted into slot 40 of personal computer 32 and information contained on the CD-ROMs is transferred to ARS devices 14 which are inserted into connection slot 54 of ARS cartridge drive 52. Once the desired information has been downloaded to ARS devices 14, the ARS devices 14 are removed from connection slots 54 and inserted back into connection slot 36 to electrically couple to GPS receiver 10. At this point, the information transferred to ARS devices 14 is available to GPS receiver 10. In various embodiments, any suitable number of ARS devices 14 can be transferred from connection slots 34 or 36 of GPS receiver 10 to one or more connection slots 54 of cartridge drive 52 so that information can be downloaded to ARS devices 14. In other embodiments, there can be any suitable number of connection slots 34 or 36 on GPS receiver 10, or any suitable number of connection slots 54 on cartridge drive 52.

FIG. 4 is a diagram illustrating a third exemplary embodiment of information being transferred between personal computer 32 and GPS receiver 10. In the illustrated embodiment, a wireless transmitter/receiver 62 is coupled to external input 24 of GPS receiver 10 via line 64. Wireless transmitter/receiver 62 includes an antenna 66. In other embodiments, transmitter/receiver 62 and antenna 66 are not external to GPS receiver 10 and are incorporated with GPS receiver 10. A wireless transmitter/receiver 68 is coupled to personal computer 32 via cable connector 70. Wireless transmitter/receiver 68 includes an antenna 72. In the illustrated embodiment, GPS transmitter/receiver 62 transmits information to and receives information from transmitter/receiver 68 so that information can be transferred between personal computer 32 and GPS receiver 10. In one embodiment, information transmitted to GPS receiver 10 can be stored in one or more ARS devices 14. In one embodiment, information is read from ARS devices 14 and transmitted to personal computer 32. In other embodiments, GPS transmitter/receiver 62 transmits information to and receives information from other suitable sources having transmitter/receiver capability. These other suitable sources include, but are not limited to, cellular telephone systems and two-way radio systems.

In one embodiment, wireless transmitter/receivers 54 and 68 use Code Division Multiple Access (CDMA) technology. In various embodiments, CDMA technology uses bandwidths which include 800 MHz and 1900 MHz. In one embodiment, wireless transmitter/receivers 54 and 68 use Time Division Multiple Access (TDMA) technology. In various embodiments, TDMA technology uses bandwidths which include 800 MHz and 1900 MHz. In one embodiment, wireless transmitter/receivers 54 and 68 use Global System for Mobile Communication (GSM) technology. In various embodiments, GSM technology uses bandwidths which include 900 MHz and 1900 MHz. In one embodiment, wireless transmitter/receivers 54 and 68 use Personal Communication System (PCS) technology.

In one embodiment, wireless transmitter/receivers 54 and 68 use the Bluetooth® wireless specification. The Bluetooth® specification uses a 2.4 GHz spectrum and communication is performed with a spread spectrum, frequency hopping, full-duplex signal at up to 1600 hops/sec. With the Bluetooth® specification, communication hops among 79 frequencies at 1 MHz intervals. In other embodiments, wireless transmitter/receivers 54 and 68 use other suitable communications technologies or specifications.

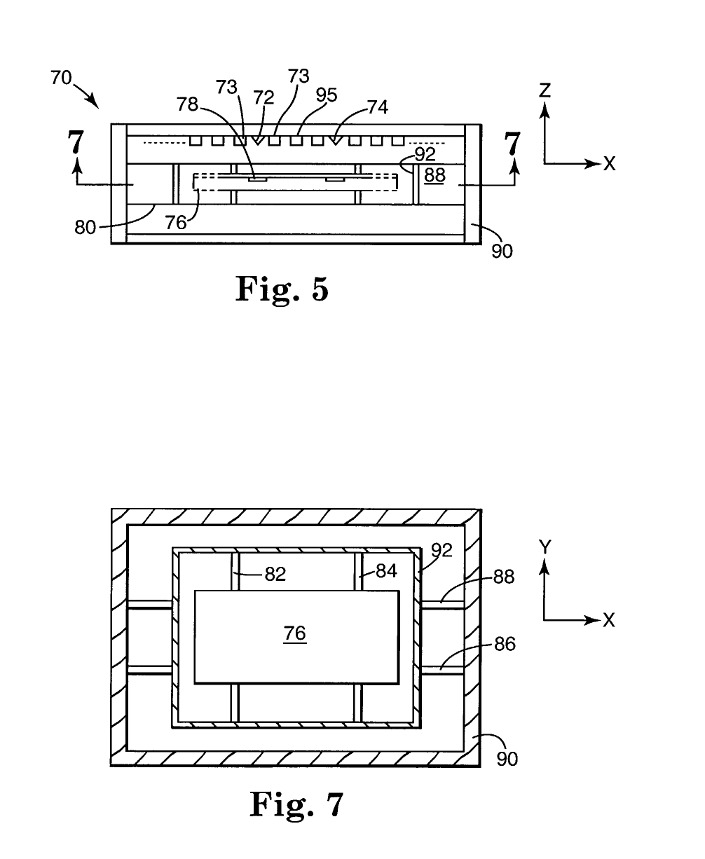

FIGS. 5 through 9 disclose one exemplary embodiment of ARS devices 14 which are configured for use in GPS receiver 10. For a further discussion of an atomic resolution storage device, see U.S. Pat. No. 5,557,596, entitled, “Ultra-High Density Storage Device”, by Gibson et al. and assigned to Hewlett-Packard Company, which has been incorporated herein by reference.

FIG. 5 illustrates at 70 a side cross-sectional view of one exemplary embodiment of an ARS device used in GPS receiver 10. ARS device 70 is one exemplary embodiment of ARS device 14. ARS device 70 includes a number of electron emitters, such as electron emitters 72 and 74, storage medium 76 including a number of storage areas, such as storage area 78, and micromover 80. Micromover 80 scans storage medium 76 with respect to the electron emitters or vice versa. Each storage area is responsible for storing one or more bits of information.

In one embodiment, the electron emitters are point emitters having very sharp points. Alternatively, other electron emitters having any suitable shape may be used (e.g., flat or planar electron emitters). Each point emitter can have a radius of curvature in the range of approximately one nanometer to hundreds of nanometers. During operation, a pre-selected potential difference is applied between an electron emitter and its corresponding gate, such as between electron emitter 72 and gate 73 surrounding it. Due to the sharp point of the emitter, an electron beam current is extracted from the emitter towards the storage area. Depending on the distance between the emitters and the storage medium 76, the type of emitters, and the spot size (bit size) required, electron optics may be utilized to focus the electron beams. A voltage may also be applied to the storage medium 76 to accelerate the emitted electrons and to aid in focusing the emitted electrons.

In one embodiment, casing 90 maintains storage medium 76 in a partial vacuum, such as at least 10⁻⁵ torr. It is known in the art to fabricate such types of microfabricated electron emitters in vacuum cavities using semiconductor processing techniques. See, for example, “Silicon Field Emission Transistors and Diodes,” by Jones, published in IEEE Transactions on Components, Hybrids and Manufacturing Technology, 15, page 1051, 1992.

In the embodiment illustrated in FIG. 5, each electron emitter has a corresponding storage area. In another embodiment, each electron emitter is responsible for a number of storage areas. As micromover 80 scans storage medium 76 to different locations, each emitter is positioned above different storage areas. With micromover 80, an array of electron emitters can scan over storage medium 76.

In various embodiments, the electron emitters read and write information on the storage areas by means of the electron beams they produce. Thus, electron emitters suitable for use in ARS device 70 are the type that can produce electron beams that are narrow enough to achieve the desired bit density on the storage medium and which can provide the different power densities of the beams needed for reading from and writing to the medium. A variety of approaches are known in the art that are suitable to make such electron emitters. For example, one method is disclosed in “Physical Properties of Thin-Film Field Emission Cathodes with Molybdenum Cones,” by Spindt et al, published in the Journal of Applied Physics, Vol. 47, No. 12, December 1976. Another method is disclosed in “Fabrication and Characteristics of Si Field Emitter Arrays,” by Betsui, published in Tech. Digest 4^{th} Int. Vacuum Microelectronics Conf., Nagahama, Japan, page 26, 1991.

In one embodiment, there can be a two-dimensional array of emitters, such as 100 by 100 emitters, with an emitter pitch of 5 to 50 micrometers in both the X and the Y directions. Each emitter may access tens of thousands to hundreds of millions of storage areas. For example, the emitters scan over the storage areas with a periodicity of about 1 to 100 nanometers between any two storage areas. Also, the emitters may be addressed simultaneously or sequentially in a multiplexed manner. Such a parallel accessing scheme significantly increases data rate of the storage device.

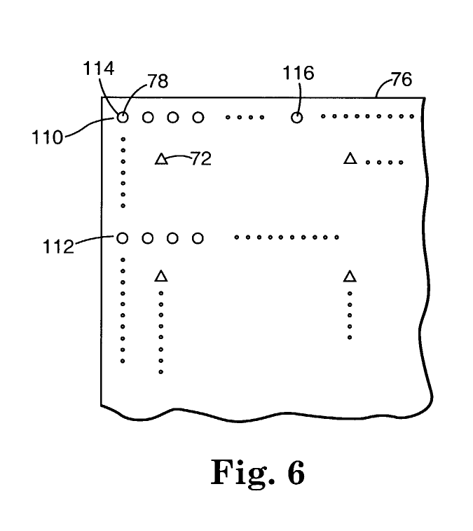

FIG. 6 illustrates a top view of storage medium 76 which includes a two-dimensional array of storage areas and a two-dimensional array of emitters. Addressing the storage areas requires external circuits. One embodiment to reduce the number of external circuits is to separate the storage medium into rows, such as rows 110 and 112, where each row contains a number of storage areas. Each emitter is responsible for a number of rows. However, in this embodiment, each emitter is not responsible for the entire length of the rows. For example, emitter 72 is responsible for the storage areas within rows 110 through 112, and within columns 114 through 116. All rows of storage areas accessed by one emitter are connected to one external circuit. To address a storage area, the emitter responsible for the particular storage area is activated and moved by micromover 80 (illustrated in FIG. 5) to the storage area. The external circuit connected to the rows of storage areas within which the particular storage area lies is activated.

In various embodiments, micromover 80 can also be made in a variety of ways, as long as it has sufficient range and resolution to position the electron emitters over the storage areas. In one embodiment, micromover 80 is fabricated by standard semiconductor microfabrication processes and scans storage medium 76 in the X and Y directions with respect to casing 90.

FIG. 7 illustrates a top view of cross section 7-7 in FIG. 5. FIG. 5 illustrates storage medium 76 being held by two sets of thin-walled microfabricated beams. The faces of the first set of thin-walled beams are in the Y-Z plane as illustrated at 82 and 84. Thin-walled beams 82 and 84 may be flexed in the X direction allowing storage medium 76 to move in the X direction with respect to casing 90. The faces of the second set of thin-walled beams are in the X-Z plane as illustrated at 86 and 88. Thin-walled beams 86 and 88 allow storage medium 76 to move in the Y direction with respect to casing 90. Storage medium 76 is held by the first set of beams, which are connected to frame 92. Frame 92 is held by the second set of beams, which are connected to casing 90. The electron emitters scan over storage medium 76, or storage medium 76 scans over the electron emitters in the X-Y directions by electrostatic, electromagnetic, piezoelectric, or other means known in the art. In this example, micromover 80 moves storage medium 76 relative to the electron emitters. A general discussion of suitable microfabricated micromovers can be found, for example, in “Novel Polysilicon Comb Actuators for XY-Stages,” published in the Proceeding of MicroElectro Mechanical Systems 1992, written by Jaecklin et al.; and in “Silicon Micromechanics: Sensors and Actuators on a Chip”, by Howe et al., published in IEEE Spectrum, page 29, in July 1990.

In other embodiments, the electron beam currents are rastered over the surface of storage medium 76 by either electrostatically or electromagnetically deflecting them, such as by electrostatic deflectors or electrodes 95 (illustrated in FIG. 5) which are positioned adjacent to emitter 74. Many different approaches to deflecting electron beams are known in the art and can be found in literature on Scanning Electron Microscopy.

In one embodiment, writing is accomplished by temporarily increasing the power density of the electron beam current to modify the surface state of the storage area. Reading is accomplished by observing the effect of the storage area on the electron beam, or the effect of the electron beam on the storage area. In one embodiment, a storage area that has been modified can represent a bit 1, and a storage area that has not been modified can represent a bit 0, and vice versa. In other embodiments, the storage area can be modified to different degrees to represent more than two bits. In other embodiments, the modifications can be permanent, or can be reversible. The permanently modified storage medium is suitable for write-once-read-many memory (WORM).

In one embodiment, the basic approach is to alter the structure of the storage area in such a way as to vary its secondary electron emission coefficient (SEEC), its back-scattered electron coefficient (BEC), or the collection efficiency for secondary or back-scattered electrons emanating from the storage area. The SEEC is defined as the number of secondary electrons generated from the medium for each electron incident onto the surface of the medium. The BEC is defined as the fraction of the incident electrons that are scattered back from the medium. The collection efficiency for secondary/back-scattered electrons is the fraction of the secondary/back-scattered electrons that are collected by an electron collector and typically registered in the form of a current.

In various embodiments, reading is accomplished by collecting the secondary and/or back-scattered electrons when an electron beam with a lower power density is applied to storage medium 76. During reading, the power density of the electron beam should be kept low enough so that no further writing occurs.

One embodiment of storage medium 76 includes a material whose structural state can be changed from crystalline to amorphous by electron beams. The amorphous state has a different SEEC and BEC than the crystalline state, which leads to a different number of secondary and back-scattered electrons emitted from the storage area. By measuring the number of secondary and back-scattered electrons, the state of the storage area can be determined. To change the storage area from the amorphous to crystalline state, the beam power density is increased and then slowly decreased. This heats up the amorphous storage area material and then slowly cools it so that the area has time to anneal into the crystalline state. To change from the crystalline to the amorphous state, the beam power density is increased to a high level and then rapidly decreased. To read from the storage medium, a lower-energy beam strikes the storage area. In various embodiments, materials such as germanium telluride (GeTe) or ternary alloys based on GeTe can be used. Similar methods to modify states using laser beams as the heating source have been described in “Laser-induced Crystallization of Amorphous GeTe: A Time-Resolved Study,” by Huber and Marinero, published in Physics Review B 36, page 1595, in 1987, and will not be further described here.

In various embodiments, there are many approaches to induce a state change in storage medium 76. In one embodiment, a change in the topography of the medium, such as a hole or bump, will modify the SEEC and BEC of the storage medium. This modification occurs because the coefficients typically depend on the incident angle of the electron beam onto the storage area. In various embodiments, changes in material properties, band structure, and crystallography may also affect the coefficients. Because the BEC depends on an atomic number, Z, in various embodiments the storage medium has a layer of low Z material on top of a layer of high Z material or vice versa, with writing accomplished through ablating a portion of the top layer by an electron beam.

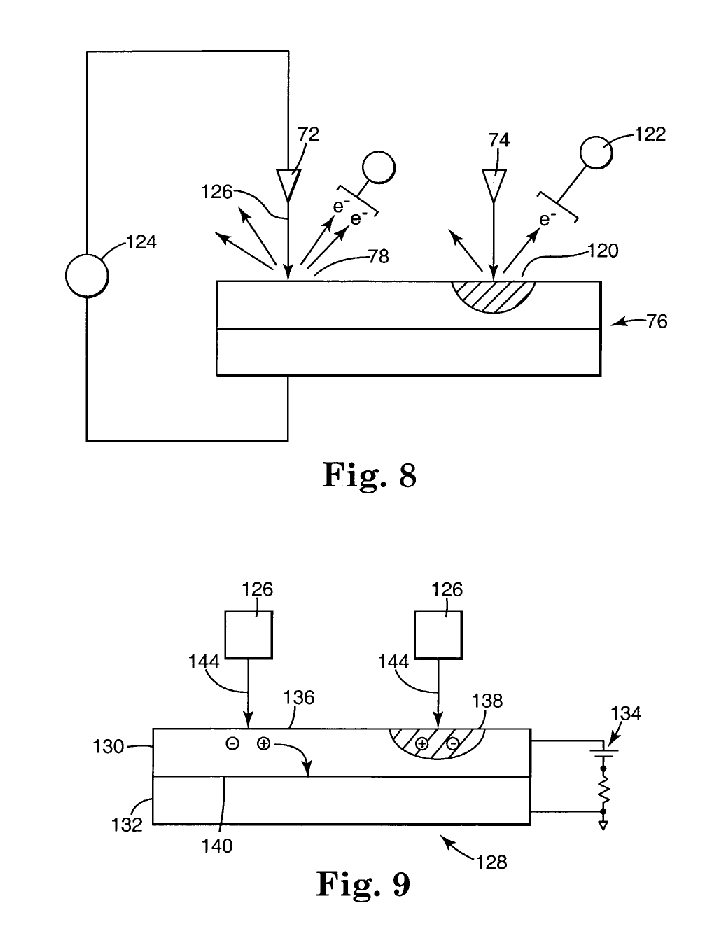

FIG. 8 shows schematically the electron emitters reading from storage medium 76. In the embodiment illustrated in FIG. 8, the state of storage area 120 has been altered, while the state of storage area 78 has not been altered. When electrons bombard a storage area, both secondary electrons and back-scattered electrons will be collected by the electron collectors, such as electron collector 122. An area that has been modified will produce a different number of secondary electrons and back-scattered electrons, as compared to an area that has not been modified. The difference may be more or may be less depending on the type of material and the type of modification. By monitoring the magnitude of the signal collected by electron collectors 122, the state of the bit stored in the storage area can be identified.

FIG. 9 illustrates an embodiment wherein, a diode structure is used to determine the state of the storage areas. According to this embodiment, the storage medium 128 is configured as a diode which can, for example, comprise a p-n junction, a schottky barrier, or any other suitable type of electronic valve. FIG. 9 illustrates an example configuration of such a storage medium 128. In other embodiments, alternative diode arrangements (such as those illustrated in U.S. Pat. No. 5,557,596) can be used. As indicated in this figure, the storage medium 128 is arranged as a diode having two layers 130 and 132. By way of example, one of the layers is p type and the other is n type. The storage medium 128 is connected to an external circuit 134 that reverse-biases the storage medium. With this arrangement, bits are stored by locally modifying the storage medium 128 in such a way that collection efficiency for minority carriers generated by a modified region 138 is different from that of an unmodified region 136. The collection efficiency for minority carriers can be defined as the fraction of minority carriers generated by the instant electrons that are swept across a diode junction 140 of the storage medium 128 when the medium is biased by the external circuit 134 to cause a current to flow through the external circuit.

In use, the electron emitters 126 emit narrow beams 144 of electrons onto the surface of the storage medium 128 that excite electron-hole pairs near the surface of the medium. Because the medium 128 is reverse-biased by the external circuit 134, the minority carriers that are generated by the incident electrons are swept toward the diode junction 140. Minority carriers that do not recombine with majority carriers before reaching the junction 140 are swept across the junction, causing a current flow in the external circuit 134.

As described above, writing is accomplished by sufficiently increasing the power density of the electron beams to locally alter the physical properties of the storage medium 128. When the medium 128 is configured as illustrated in FIG. 9, this alteration affects the number of minority carriers swept across the junction 140 when the same area is radiated with a lower power density read electron beam. For instance, the recombination rate in a written (i.e., modified) area 138 could be increased relative to an unwritten (i.e., unmodified) area 136 so that the minority carriers generated in the written area have an increased probability of recombining with majority carriers before they have a chance to reach and cross junction 140. Hence, a smaller current flows in external circuit 134 when the read electron beam is incident upon the written area 138 than when it is incident upon an unwritten area 136. Conversely, it is also possible to start with a diode structure having a high recombination rate and then writing the bits by locally reducing the recombination rate. In either case, the magnitude of the current resulting from the minority carriers depends upon the state of particular storage area.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A global positioning system receiver, comprising:
an atomic resolution storage device configured to store global positioning system information, wherein the atomic resolution storage device includes:
an electron emitter;
a media; and
a micromover operable to move the electron emitter relative to the media to read or write global positioning system information at the media.

2. The global positioning system receiver of claim 1, wherein the global positioning system information is stored on the atomic resolution storage device when the atomic resolution storage device is electrically decoupled from the global positioning system receiver, and wherein the global positioning system information can be displayed on the global positioning system receiver after the atomic resolution storage device is electrically coupled to the global positioning system receiver.

3. The global positioning system receiver of claim 2, further comprising an external input configured to receive the global positioning system information which is stored in the atomic resolution storage device.

4. The global positioning system receiver of claim 3, wherein the external input is configured to electrically couple to a personal computer.

5. The global positioning system receiver of claim 3, wherein the external input is configured to electrically couple to a CD-ROM drive.

6. The global positioning system receiver of claim 3, wherein the external input is configured to electrically couple to a wireless transmitter/receiver.

7. The global positioning system receiver of claim 6, wherein the wireless transmitter/receiver is configured to transmit and receive the global positioning system information which is displayed on the global positioning system receiver.

8. The global positioning system receiver of claim 7, wherein the global positioning system information is transmitted and received using a Code Division Multiple Access technology.

9. The global positioning system receiver of claim 7, wherein the global positioning system information is transmitted and received using a Time Division Multiple Access technology.

10. The global positioning system receiver of claim 7, wherein the global positioning system information is transmitted and received using a Global System for Mobile Communication technology.

11. The global positioning system receiver of claim 7, wherein the global positioning system information is transmitted and received using a Personal Communication System technology.

12. The global positioning system receiver of claim 7, wherein the global positioning system information is transmitted and received using a Bluetooth® wireless specification.

13. The global positioning system receiver of claim 1, wherein the atomic resolution storage device is approximately 1 centimeter wide by 1 centimeter long by 2 millimeters high.

14. The global positioning system receiver of claim 1, wherein the atomic resolution storage device has a standby power requirement of less than 1 watt.

15. The global positioning system receiver of claim 1, wherein the atomic resolution storage device has a storage capacity which is greater than 100 megabytes.

16. A global positioning system receiver, comprising:
at least one atomic resolution storage device configured to store global positioning system information which is displayed on the global positioning system receiver, wherein each of the at least one atomic resolution storage devices includes:
an array of electron emitters fabricated by semiconductor microfabrication techniques capable of generating electron beams;
a storage medium in proximity to the electron emitters, wherein the storage medium has storage areas in one of a plurality of states to represent global positioning system information stored in the storage area; and
a micromover for positioning the storage medium relative to the array of electron emitters.

17. The global positioning system receiver of claim 16, wherein the at least one atomic resolution storage devices are located on a single silicon based unit.

18. The global positioning system receiver of claim 16, wherein the at least one atomic resolution storage devices are each located on separate silicon based units.

19. The global positioning system receiver of claim 16, wherein an effect is generated when the electron beam current bombards the storage area, wherein the magnitude of the effect depends on the state of the storage area, and wherein the global positioning system information stored in the storage area is read by measuring the magnitude of the effect.

20. A global positioning system receiver, comprising:
a control system configured to receive transmitted global positioning system signals and calculate a location of the global positioning system receiver;
an atomic resolution storage device for storing global positioning system information, wherein the atomic resolution storage device includes:
an electron emitter;
a media; and
a micromover operable to move the electron emitter relative to the media to read or write global positioning system data at the media; and
a display configured to display the global positioning system information and the location relative to the global positioning system information.

21. The global positioning system receiver of claim 20, wherein the global positioning system information includes a navigation map.

22. The global positioning system receiver of claim 20, wherein the global positioning system information includes a topographical map.

23. The global positioning system receiver of claim 20, wherein the global positioning system information includes a three-dimensional map.

24. A method of storing global positioning system information in a global positioning system receiver, comprising:
providing an atomic resolution storage device, wherein the atomic resolution storage device is configured to store global positioning system information, the atomic resolution storage device including:
an electron emitter; and
a media; and
storing the global positioning system information in the atomic resolution storage device, including moving the electron emitter relative to the media to read or write global positioning system information at the media.

25. A method of storing global positioning system information in a global positioning system receiver, comprising:
providing an atomic resolution storage device, wherein the atomic resolution storage device is configured to store global positioning system information, the atomic resolution storage device including:
an electron emitter; and
a media;
electrically decoupling the atomic resolution storage device from the global positioning system receiver;
storing the information in the atomic resolution storage device including moving the electron emitter relative to the media to read or write global positioning system information at the media; and
electrically coupling the atomic resolution storage device to the global positioning system receiver

26. The method of claim 25, further including displaying the global positioning system information on the global positioning system receiver after the atomic resolution storage device is electrically coupled to the global positioning system receiver.

27. A method of storing global positioning system information in a global positioning system receiver, comprising:
providing an atomic resolution storage device, wherein the atomic resolution storage device is configured to store global positioning system information, the atomic resolution storage device including:
an electron emitter; and
a media;
providing a wireless transmitter/receiver electrically coupled to the atomic resolution storage device, wherein the wireless transmitter/receiver is configured to transmit or receive, within a bandwidth, the global positioning system information which is stored on the atomic resolution storage device;
receiving the global positioning system information within the bandwidth; and
storing the global positioning system information in the atomic resolution storage device, including moving the electron emitter relative to the media to read or write global positioning system information at the media.

28. A method of storing global positioning system information in a global positioning system receiver, comprising:
providing an atomic resolution storage device, wherein the atomic resolution storage device is configured to store the global positioning system information which can be displayed on the global positioning system receiver, wherein the atomic resolution storage device includes:
an electron emitter; and
a media;
providing a CD-ROM which contains the global positioning system information; and
transferring the global positioning system information from the CD-ROM to the atomic resolution storage device, including moving the electron emitter relative to the media to read or write global positioning system information at the media.

29. A method of manufacturing a global positioning system receiver, comprising:
providing an atomic resolution storage device, wherein the atomic resolution storage device includes:
an electron emitter;
a media; and
a micromover operable to move the electron emitter relative to the media to read or write global positioning system information at the media; and
installing the atomic resolution storage device in the global positioning system receiver so that the atomic resolution storage device is electrically coupled to the global positioning system receiver.
